(19) United States
(12) Patent Application Publication
(10) Pub. No.: US 2003/0106227 A1
(43) Pub. Date: Jun. 12, 2003

(54) Level with a hollow section

(75) Inventor: Walter Horburger, Gotzis (AT)

Correspondence Address: Friedrich Kueffner, Suite 910, 317 Madison Avenue, New York, NY, 10017, US

(73) Assignee: Ing. Guido Scheyer SOLA-Messwerkzeuge Gesellschaft m. b. H. & Co.

(21) Appl. No.: 10/302,590

(22) Filed: Nov. 22, 2002

(30) Foreign Application Priority Data
Dec. 6, 2001 (AT) A 1909/2001

(51) Int. Cl. G01C 9/10

(52) U.S. Cl. 33/365

(57) ABSTRACT

A level is composed of a hollow section having two narrow sides, two wide sides and two end faces, wherein at least one of the narrow sides forms a contact surface. The level also includes at least one horizontal bubble and a vertical bubble for carrying out a horizontal and a vertical measurement. The vertical bubble and the horizontal bubble are located outside of the area surrounded by the hollow section and are mounted in side components attached to the end faces of the hollow section.

### BACKGROUND OF THE INVENTION

1. Field of the Invention

The present invention relates to a level composed of a hollow section with two narrow sides, wherein at least one narrow side forms a contact surface, two wide sides and two end faces, and with at least one horizontal bubble and a vertical bubble for carrying out a horizontal measurement and a vertical measurement.

2. Description of the Related Art

In conventional levels of the above-described type, cutouts are provided for the horizontal and vertical bubbles in the level body formed by the hollow section. A level of this type is shown, for example, in DE 83 34 916 U1. The vertical bubble for carrying out the vertical measurement is secured within the hollow section and can be read through a window recess in the hollow section. The horizontal bubble for carrying out a horizontal measurement is also arranged in the interior of the hollow section and can be read through a recess extending from the narrow side which is located opposite the narrow side which forms the contact surface. In the device shown in DE 83 34 916 U1, the alignment of the bubble in relation to the hollow section is achieved by means of interacting guide elements which are provided on the bubble body as well as on the hollow section.

In other conventional levels, a bubble support is provided relative to which the bubble body can be aligned during assembly of the level, wherein, subsequently, the bubble body is secured relative to the bubble support, for example, by means of clamping elements, ultrasound welding, gluing, foaming of the bubble body, etc. Such a bubble support, relative to which the bubble body is alignable, is known, for example, from DE 36 06 774 C2.

In the levels shown in DE 33 14 509 A1 and DE 72 34 521 U1, the horizontal and vertical bubbles are arranged in receiving housings or bubble supports located in the level body. As is the case in the above-mentioned DE 83 34 916 U1, a recess extending from the narrow side which is located opposite the narrow side which forms the contact surface is provided for reading the horizontal bubble. In these devices, the vertical bubble is arranged in a portion of the hollow section located adjacent the end face of the hollow section and a recess extending from the narrow side is provided in the hollow section for reading the vertical bubble. As a result of this arrangement of the vertical bubble, it is possible to read the vertical bubble not only from the side but also in the axial direction of the level.

In all of these known levels, recesses must be provided in the level when the level is manufactured, particularly by means of cutouts. In order to achieve the required accuracy of the level, the hollow sections, particularly in the case of long levels, are usually of metal, specifically of aluminum. The manufacture of cutouts in the hollow sections forming the level body requires an additional work step.

### SUMMARY OF THE INVENTION

Therefore, it is the primary object of the present invention to provide a level which is simpler and can be manufactured more economically.

In accordance with the present invention, the vertical bubble and the horizontal bubble are located outside of the area surrounded by the hollow section and are provided in side components arranged at the end faces of the hollow section.

In the level according to the present invention, recesses in the hollow section for the bubbles are not required. The hollow section can advantageously be manufactured without recesses.

The level according to the present invention makes it possible to simplify the manufacture of the entire level. Also, because the level has no recesses, it is possible to provide a continuous surface for imprints, for example, an advertising area, on the wide side of the hollow section.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of a first embodiment of the level according to the present invention;

FIGS. 2 and 3 are side views of slightly modified embodiments, wherein, for clarity's sake, the length of the hollow section is shortened.

FIGS. 4-6 are schematic exploded perspective views of additional embodiments of the present invention, wherein the length of the hollow section is again shortened; and

FIG. 7 is a sectional view taken along sectional line A-A of FIG. 3.

### DESCRIPTION OF THE PREFERRED EMBODIMENTS

Each of the levels illustrated in the drawing has a hollow section 1 in the form of a rectangular section with two narrow sides 2, 3, two wide sides 4, 5 and two end faces 6, 7, wherein the lower narrow side 3 forms a contact surface. In the illustrated embodiments, the narrow sides 2, 3 and the wide sides 4, 5 are constructed as plane surfaces. Basically, the sides of the level may also be profiled. For example, the wide sides 4, 5 can be formed by two sections arranged at an angle relative to each other and connected to each other vertically, so that, for example, an inwardly directed, V-shaped section is formed in cross-section.

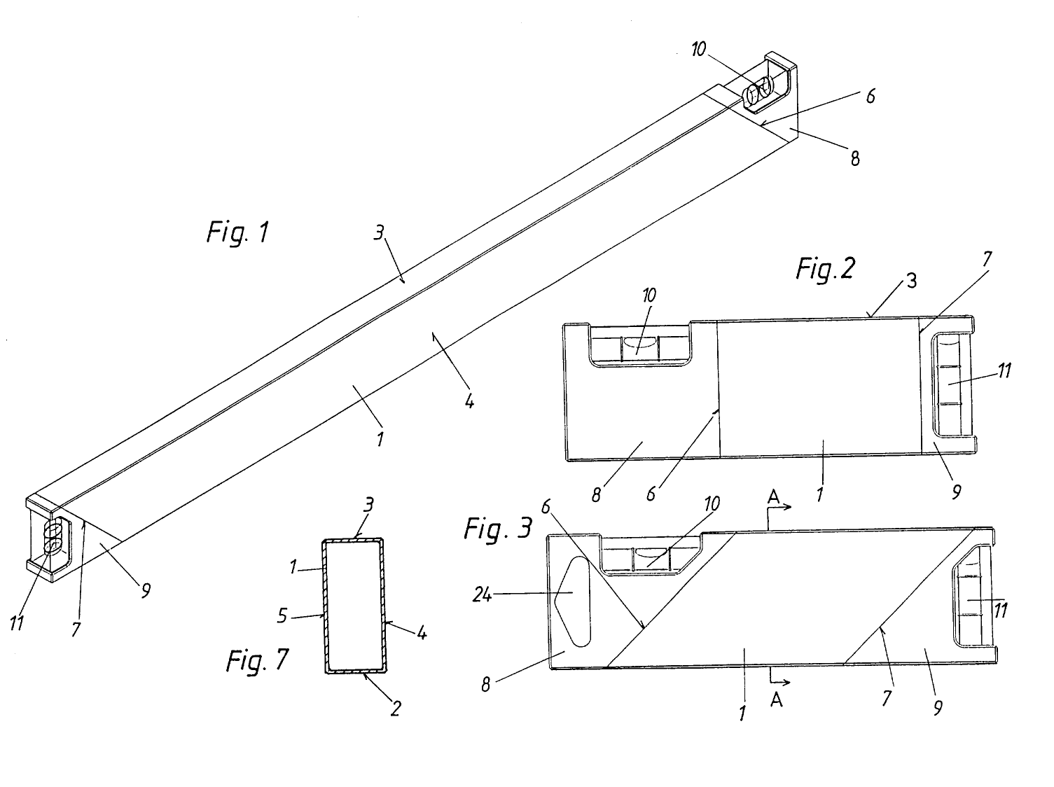

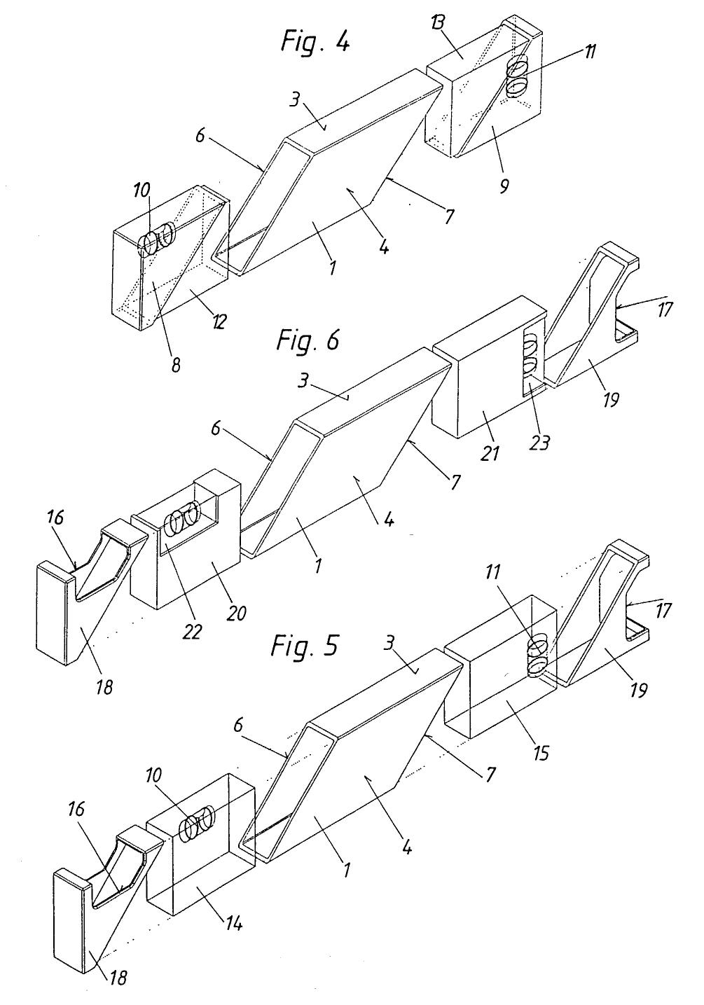

In the embodiment of FIG. 2, the end faces 6, 7 extend perpendicularly of the longitudinal extension of the hollow section 1 as seen in the side view, while in the other embodiments the end faces 6, 7 are inclined, i.e., they extend at an angle deviating from 90° relative to the longitudinal axis of the hollow section 1. A side component 8, 9 is arranged at each end face 6, 7, wherein, in the assembled state of the level shown in FIGS. 1-3, the side components are connected immediately to the end faces 6, 7 and constitute an extension of the hollow section 1. Consequently, the level body is formed by the hollow section 1 and the side components 8, 9 attached to the end faces. In the schematic exploded views of FIGS. 4-6, these components are illustrated separately.

The level includes a horizontal bubble 10 for carrying out a horizontal measurement and a vertical bubble 11 for carrying out a vertical measurement. These bubbles 10, 11 are arranged in the side components 8, 9 and are located outside of the area surrounded by the hollow section 1. The horizontal bubble 10 is arranged in one side component 8 and the vertical bubble 11 is arranged in the other side component 9.

The hollow section 1 is preferably of aluminum and the side components 8, 9 are preferably at least essentially of plastics material. Because of the arrangement of the bubbles 10, 11 outside of the area surrounded by the hollow section 1 in the side components 8, 9, the narrow sides 2, 3 and the wide sides 4, 5 of the hollow section 1 can be constructed as closed surfaces without cutouts.

For fastening the side components 8, 9 to the hollow section 1, the side components 8, 9 may have portions extending into the interior of the hollow section 1, wherein these portions are secured to the hollow section 1, for example, by gluing, clamping or welding.

In the embodiments illustrated in the drawing, the side components 8, 9 extend flush with the hollow section 1 and the narrow sides 2, 3 and the wide sides 4, 5 of the hollow section are continued in the respective planes by the side components 8, 9.

In the embodiment schematically illustrated in FIG. 4, the side components 8, 9 are formed by appropriately shaped bubble bodies of the horizontal and vertical bubbles. Each bubble body has a portion 12, 13 with cross-sectional dimensions which are reduced as compared to the remaining portion of the bubble body in which the bubble 10, 11 is arranged. This portion 12, 13 can be pushed with little play into the interior of the hollow section 1. The play between the bubble body and the hollow section 1 could in this case be utilized for aligning the bubble. For example, the portion 12, 13 can be provided with an adhesive and the adhesive can be allowed to harden after the portions 12, 13 have been inserted into the hollow section 1 and the side components 8, 9 have been aligned.

In the embodiment illustrated in FIG. 5, the side components 8, 9 are constructed of several components and include a bubble body 14, 15 and a cover 18, 19 provided with a view window 16 for the bubble 10, 11, wherein the cover 18, 19 is preferably manufactured as an injection molded component of plastics material. The bubble body 14, 15 can be inserted with little play in the interior of the hollow section and can be secured in the hollow section, possibly after a previous alignment of the bubble body. The cover 18, 19 can be slid onto the bubble body 14, 15 until it rests flush against the hollow section 1 and can be secured in this position at the bubble body 14, 15, for example, by gluing.

In the embodiment schematically illustrated in FIG. 6, each bubble body 22, 23 is secured in a bubble support 20, 21. The bubble support 20, 21 can be inserted with little play into the interior of the hollow section 1 and can be attached to the hollow section 1. The bubble body 22, 23 can be aligned relative to the bubble support 20, 21 in various ways, as this is known from conventional levels. In the aligned position, the bubble body 22, 23 is secured relative to the bubble support 20, 21 preferably after the bubble support 20, 21 has already been mounted in the hollow section 1. It is possible to provide cap-shaped covers 18, 19 which can be slid over the bubble support 20, 21 until they rest flush against the hollow section 1 and which are secured in this position. These covers 18, 19 each have a view window 16, 17 for the bubbles.

In addition, in the embodiment illustrated in FIG. 3, a hole 24 for hanging up the level is provided in the side component 8. Accordingly, no cutout is required in the hollow section 1 itself for this hole 24.

In principle, it would be conceivable and possible to provide stiffening ribs, separating walls or the like in the interior of the hollow section 1. Stiffening ribs could also be provided at the outer sides of the hollow section 1, for example, in the form of ribs which extend longitudinally of the hollow section at the wide sides 4. It would basically also be conceivable and possible to provide both narrow sides 2, 3 as contact surfaces.

While specific embodiments of the invention have been shown and described in detail to illustrate the inventive principles, it will be understood that the invention may be embodied otherwise without departing from such principles.

I claim:

1. A level comprising a hollow section having two narrow sides, two wide sides and two end faces, wherein at least one of the narrow sides forms a contact surface, and at least one horizontal bubble and a vertical bubble for carrying out a horizontal measurement and a vertical measurement, further comprising side components arranged at the end faces of the hollow section, wherein the vertical bubble and the horizontal bubble are arranged in the side components outside of an area surrounded by the hollow section.

2. The level according to claim 1, wherein the horizontal bubble is arranged in one of the side components and the vertical bubble is arranged in another of the side components.

3. The level according to claim 1, wherein each side components comprises a portion extending into an interior of the hollow section for securing the side component to the hollow section.

4. The level according to claim 1, wherein the side components have narrow sides and wide sides in alignment with the narrow sides and wide sides of the hollow section.

5. The level according to claim 1, wherein each side component is comprised of a bubble body.

6. The level according to claim 5, wherein each bubble body comprises a portion having reduced cross-sectional dimensions relative to the portion of the bubble body in which the bubble is arranged, wherein each portion with reduced cross-sectional dimensions is configured to be insertable with little play into an interior of the hollow section.

7. The level according to claim 1, wherein each side component is comprised of a bubble body configured to be insertable at least partially with little play into an interior of the hollow section, and a cover provided with a view window for the bubble.

8. The level according to claim 7, wherein the cover with the view window for the bubble is of plastics material.

9. The level according to claim 1, wherein each side component comprises a bubble support supporting a bubble body, wherein the bubble support is attached to the hollow section.

10. The level according to claim 9, wherein the bubble support is configured to be insertable at least with a portion thereof with little play into an interior of the hollow section.

11. The level according to claim 9, wherein each side component additionally comprises a cover with a view window for the bubble, wherein the cover surrounds the bubble support and extends flush with the hollow section.

12. The level according to claim 1, wherein the narrow sides and the wide sides are closed surfaces without cutouts.

13. The level according to claim 1, wherein the side components are at least essentially of plastics material.

14. The level according to claim 1, wherein the hollow section is of aluminum.
